(19) United States
(12) Patent Application Publication
(10) Pub. No.: US 2013/0258074 A1
(43) Pub. Date: Oct. 3, 2013

(54) ELECTRONIC DEVICE AND METHOD FOR PROMPTING OVERTIME USAGE OF ELECTRONIC DEVICE

(71) Applicants: Na-Na ZHAI, Shenzhen City (CN); Yu-Cui ZHOU, Shenzhen City (CN); Xiao-Jun CHEN, Shenzhen City (CN); Qiao-Na SHENG, Shenzhen City (CN); Chun-Yan YANG, Shenzhen City (CN)

(72) Inventors: Na-Na ZHAI, Shenzhen City (CN); Yu-Cui ZHOU, Shenzhen City (CN); Xiao-Jun CHEN, Shenzhen City (CN); Qiao-Na SHENG, Shenzhen City (CN); Chun-Yan YANG, Shenzhen City (CN)

(73) Assignees: HON HAI PRECISION INDUSTRY CO., LTD., Tu-Cheng (TW); Fu Tai Hua Industry (ShenZhen) Co., Ltd., ShenZhen City (CN)

(21) Appl. No.: 13/459,101

(22) Filed: Apr. 28, 2012

(30) Foreign Application Priority Data
Mar. 30, 2012 (CN) 201210089749.9

(51) Int. Cl. H04N 7/18

(52) U.S. Cl. 348/61; 348/E07.085

(57) ABSTRACT

An electronic device includes an image capturing unit and a processor. The image capturing unit captures image of a front of the electronic device. The processor periodically controlling the image capturing unit to capture the image of a front of the electronic device, determines whether a user begins to use the electronic device according to the image captured by the image capturing unit, begins to time if the user begins to use the electronic device, and generates a prompt if the timed time reaches to a predetermined time.

### BACKGROUND

1. Technical Field

The present disclosure relates to an electronic device and a method for prompting overtime usage of the electronic device.

2. Description of Related Art

Some electronic devices have a function for prompting user to take a break or turns off the electronic device directly after the electronic device has been used for a predetermined time. This prevents the user from extending the use of the electronic device to long, which can be harmful to ones health. However, if one electronic device is to be used by different users at different times, while a different user, instead of the previous user, is using the electronic device when the time reaches the predetermined time, the electronic device may be turned off or generate a prompt to prompt the other user to take a break, which will disturb the present user using the electronic device.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an electronic device for prompting overtime using of the electronic device in accordance with an exemplary embodiment.

FIG. 2 is a flowchart of a method for prompting overtime using of the electronic device of FIG. 1.

FIG. 3 is a flowchart of a method to determine whether the user begins to use the electronic device 1 of FIG. 1 in a first situation.

FIG. 4 is a flowchart of a method to determine whether the user begins to use the electronic device 1 of FIG. 1 in a second situation.

### DETAILED DESCRIPTION

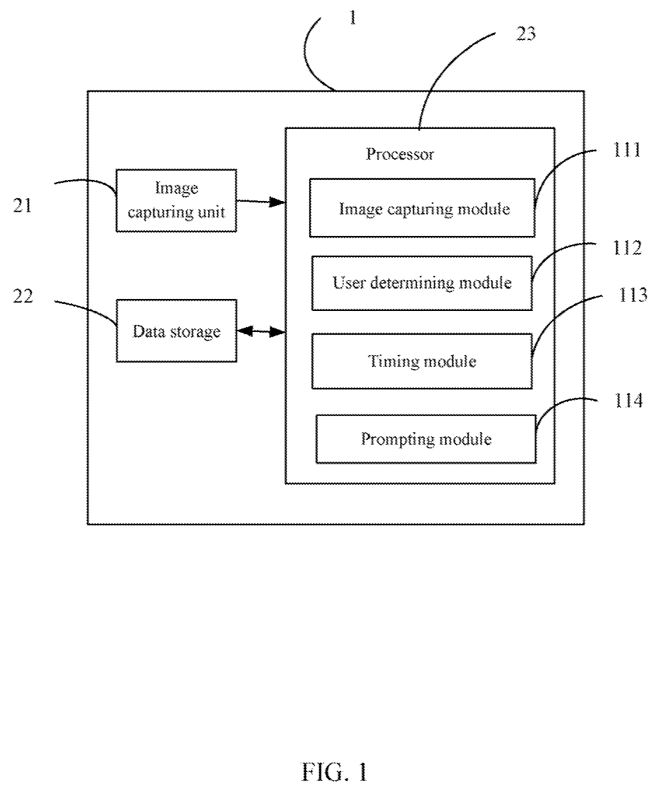

FIG. 1 is a block diagram of an electronic device 1 for prompting overtime usage of the electronic device in accordance with an exemplary embodiment. The electronic device 1 includes an image capturing unit 21, a data storage 22, and a processor 23. The image capturing unit 21 is for capturing image of a front of the electronic device 1. The data storage 22 stores an original image which includes a user.

The processor 23 includes an image capturing module 111, a user determining module 112, a timing module 113, and a prompting module 114. One or more programs of the above function modules may be stored in the data storage 22 and executed by the processor 23. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device.

The image capturing module 111 periodically controls the image capturing unit 21 to capture the image of a front of the electronic device 1. The user determining module 112 determines whether the user begins to use the electronic device according to the image captured by the image capturing unit 21. The method for determining whether the user begins to use the electronic device 1 will be described below. The timing module 113 begins to time if the user determining module 112 determines the user begins to use the electronic device 1. The prompting module 114 determines whether the time which the timing module 113 measures reaches to a predetermined time if the user determining module 112 determines the user does not begin to use the electronic device 1, namely the use has used the electronic device for a period of time. If the time measured by the timing module 113 reaches to the predetermined time, the prompting module 114 prompts the user to take a break. In the embodiment, the prompting module 114 generates a prompt message to prompt user to take a break. In other embodiments, other prompting ways, such light prompt, audio prompt, or turning off the electronic device 1 are also used to prompt the user to take a break.

In the embodiment, two situations are deemed that the user begins to use the electronic device 1. The first situation occurs after the image of a front of the electronic device 1 has been captured. The user determining module 112 determines whether the captured image includes a user, if the captured image includes a user, the user determining module 112 determines the user begins to use the electronic device, if the captured image does not include a user, the user determining module 112 goes on determining until the image including a user is detected.

The second situation occurs after the image including a user is obtained by the image capturing module 111. The user determining module 112 compares the user in a current image with the user in the original image stored in the data storage 22 to determine whether a different user is using the electronic device 1; if the user in the current image is the same as the user in the original image or similar enough, i.e., to a predetermined degree, to the user in the original image, the user determining module 112 determines the user of the electronic device 1 is not different; if the user in a current image is not the same as the user in the original image, the user determining module 112 determines a different user is using the electronic device 1, namely another user begins to use the electronic device 1.

In the embodiment, the face recognition technology is used to determine the user in the image. Because the face recognition technology is familiar to a person skilled in the art it is unnecessary to describe it in detail.

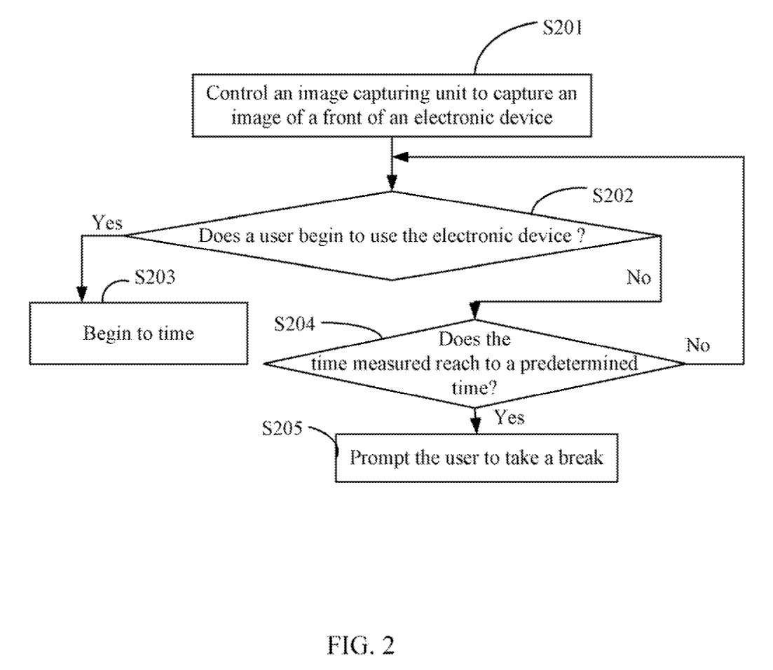

FIG. 2 is a flowchart of a method for prompting overtime usage of the electronic device of FIG. 1.

In step S201, the image capturing module 111 controls the image capturing unit 21 to capture the image of a front of the electronic device 1.

In step S202, the user determining module 112 determines whether the user begins to use the electronic device 1 according to the image captured by the image capturing unit 21. If the user begins to use the electronic device 1, the procedure goes to step S203, otherwise, the procedure goes to step S204.

In step S203, the timing module 113 begins to time.

In step S204, the prompting module 114 determines whether the time which the timing module 113 measures reaches a predetermined time. If the time measured by the timing module 113 reaches the predetermined time, the procedure goes to step S205. If the time measured by the timing module 113 does not reach the predetermined time, the procedure goes back to step S201.

In step S205, the prompting module 114 prompts the user to take a break.

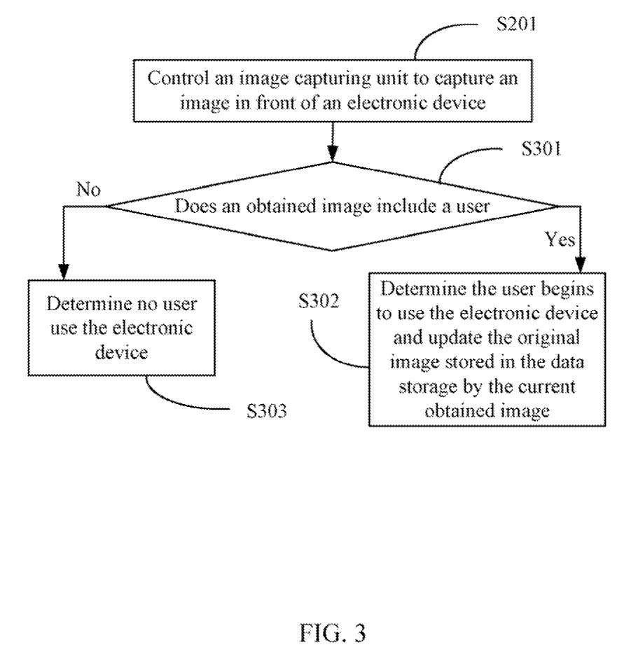

FIG. 3 is a flowchart of a method to determine whether the user begins to use the electronic device 1 of FIG. 1 in the first situation.

After the image of a front of the electronic device 1 is obtained in step S201, in step S301, the user determining module 112 determines whether the obtained image includes a user.

If the obtained image includes a user, in step S302, the user determining module 112 determines the user begins to use the electronic device 1 and updates the original image stored in the data storage 22 with the current image.

If the obtained image does not include a user, in step S303 the user determining module 112 determines no user uses the electronic device 1.

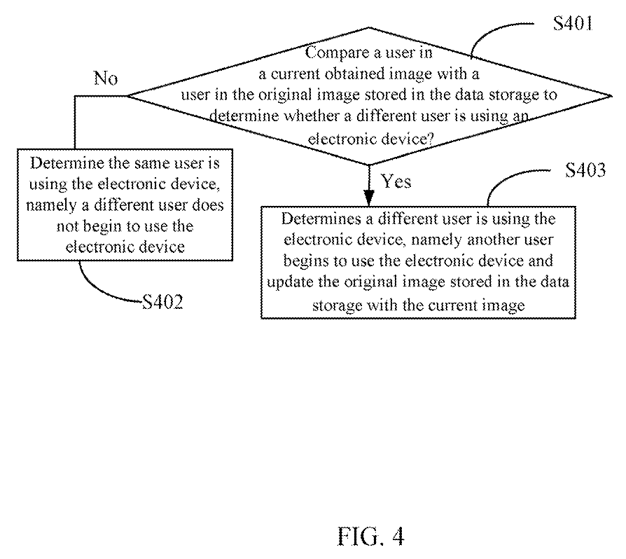

FIG. 4 is a flowchart of a method to determine whether a user begins to use the electronic device 1 of FIG. 1 in the second situation. In step S401, the user determining module 112 compares the user in a current obtained image with the user in the original image stored in the data storage 22 to determine whether a different user is using the electronic device 1.

If the user in the current image is the same as the user in the original image or similar enough, i.e., to a predetermined degree, to the user in the original image, in step S402 the user determining module 112 determines the same user is using the electronic device 1, namely a different user does not begin to use the electronic device 1.

If the user in a current image is not the same as the user in the original image, in step S403, the user determining module 112 determines a different user is using the electronic device 1, namely another user begins to use the electronic device 1 and updates the original image stored in the data storage 22 with the current image.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. An electronic device comprising:
an image capturing unit for capturing image of a front of the electronic device;
a processor comprising:
an image capturing module periodically controlling the image capturing unit to capture the image of a front of the electronic device;
a user determining module determining whether a user begins to use the electronic device according to the image captured by the image capturing unit;
a timing module beginning to time when the user determining module determines that the user begins to use the electronic device;
a prompting module determining whether the time which the timing module measures reaches to a predetermined time if the user determining module determines that the user does not begin to use the electronic device; and generates a prompt if the time measured by the timing module reaches to the predetermined time.

2. The electronic device as described in claim 1, wherein the user determining module determines whether a user begins to user the electronic device by: detecting whether the captured image includes a user after the image of a front of the electronic device is captured and determining the user begins to use the electronic device only when the image including a user is detected.

3. The electronic device as described in claim 1, wherein a data storage of the electronic device stores an original image which comprises a user, the user determining module determines whether a user begins to user the electronic device by: comparing the user in a current obtained image with the user in the original image stored in the data storage after the image including a user is obtained and determines another user begins to use the electronic device if the user in the current obtained image is not the same as the user in the original image.

4. A method for prompting overtime using of an electronic device comprising:
controlling an image capturing unit to capture the image of a front of the electronic device;
determining whether a user begins to use the electronic device according to the image captured by the image capturing unit;
beginning to time when the user begins to use the electronic device;
determining whether the measured time reaches to a predetermined time when the user does not begin to use the electronic device; and
generating a prompt to the user when the timing time reaches to the predetermined time.

5. The method as described in claim 4, wherein the step of determining whether a user begins to user the electronic device is performed by: detecting whether the captured image includes a user after the image of a front of the electronic device is captured and determining the user begins to use the electronic device only when the image including a user is detected.

6. The method as described in claim 4, wherein an original image which comprises a user is stored in the electronic device; the step of determining whether a user begins to use the electronic device is performed by: comparing the user in a current obtained image with the user in the original image stored in the data storage after the image including a user and determining a different user begins to use the electronic device if the user in a current image is not the same as or not similar enough to the user in the original image.

7. A non-transitory storage medium storing a set of instructions, the set of instructions capable of being executed by a processor to perform a method, the method comprising:
controlling an image capturing unit to capture the image of a front of the electronic device periodically;
determining whether a user begins to use the electronic device according to the image captured by the image capturing unit;
beginning to time when the user begins to use the electronic device;
determining whether the measured time reaches to a predetermined time when the user does not begin to use the electronic device; and
generating a prompt to the user when the timing time reaches to the predetermined time.

8. The non-transitory storage medium as described in claim 7, wherein determining whether a user begins to user the electronic device by: detecting whether the captured image includes a user after the image of a front of the electronic device is captured and determining the user begins to use the electronic device only when the image including a user is detected.

9. The non-transitory storage medium as described in claim 7, wherein an original image which includes a user is stored in the electronic device and the step of determining whether a user begins to user the electronic device is performed by: comparing the user in a current obtained image with the user in the original image stored in the data storage after the image including a user and determining another user begins to use the electronic device if the user in a current image is not the same as, or similar enough to, the user in the original image.
